(19) United States
(12) Patent Application Publication
(10) Pub. No.: US 2025/0245556 A1
(43) Pub. Date: Jul. 31, 2025

(54) BACKHAUL ATTACHMENT RECOMMENDATION AND OPTIMIZATION

(71) Applicant: Walmart Apollo, LLC, Bentonville, AR (US)

(72) Inventors: Tiantian Nie, Fremont, CA (US); Xiaojie Wang, Redmond, WA (US); Anushri Srinath Aithal, Fremont, CA (US); Angela Suzanne Pottorff, Chicago, IL (US); Michael Dale Turner, Bentonville, AR (US); Joseph Wayne Hendricks, Bentonville, AR (US); Himanshu Prasad, Bentonville, AR (US); Ranjith Moola, Fremont, CA (US); Darshan Rajesh Chauhan, Richardson, TX (US); Fereydoun Adbesh, Rogers, AR (US); Ti Zhang, Rocklin, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/427,408

(22) Filed: Jan. 30, 2024

(51) Int. Cl. G06N 20/00

(52) U.S. Cl. CPC G06N 20/00

(57) ABSTRACT

A method including training a machine-learning model based on pairs of historical backhauls and historical releases to recommend current releases or future releases. The method also can include determining, using the machine-learning model, recommended backhaul loads to be assigned to current releases from among available backhaul loads. The method additionally can include automatically generating matches for outbound routes with the recommended backhaul loads. Other embodiments are described.

### TECHNICAL FIELD

This disclosure relates generally to backhaul attachment recommendation and optimization.

### BACKGROUND

Trucks typically delivery outbound loads from distribution centers to stores. These deliveries to stores from the distribution centers are referred to as releases. After trucks deliver outbound loads to stores from a distribution center, the empty trucks can be used to pickup inbound loads from vendors before returning back to the distribution center. Backhaul refers to these inbound loads being picked up from vendors after outbound deliveries and transported to the distribution center.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for backhaul attachment recommendation and optimization, according to an embodiment;

FIG. 4 illustrates an exemplary portion of a transportation network;

FIG. 5 illustrates a flow chart for a method of backhaul attachment recommendation and optimization, according to an embodiment;

FIG. 6 illustrates a flow chart for a method of performing backhaul classification, according to an embodiment;

FIG. 7 shows tables for an exemplary data point;

FIG. 8 shows tables output from pre-processing and cost calculation;

FIG. 9 shows a table output from feature selection; and

FIG. 10 illustrates a flow chart for a method of performing backhaul attachment recommendation and optimization, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

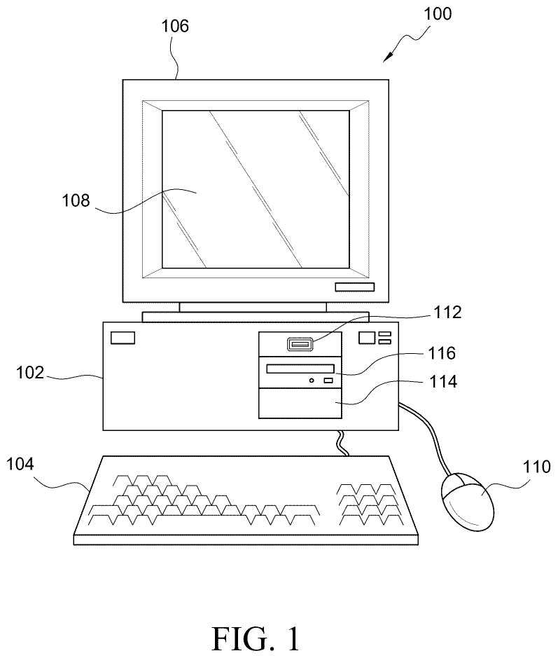

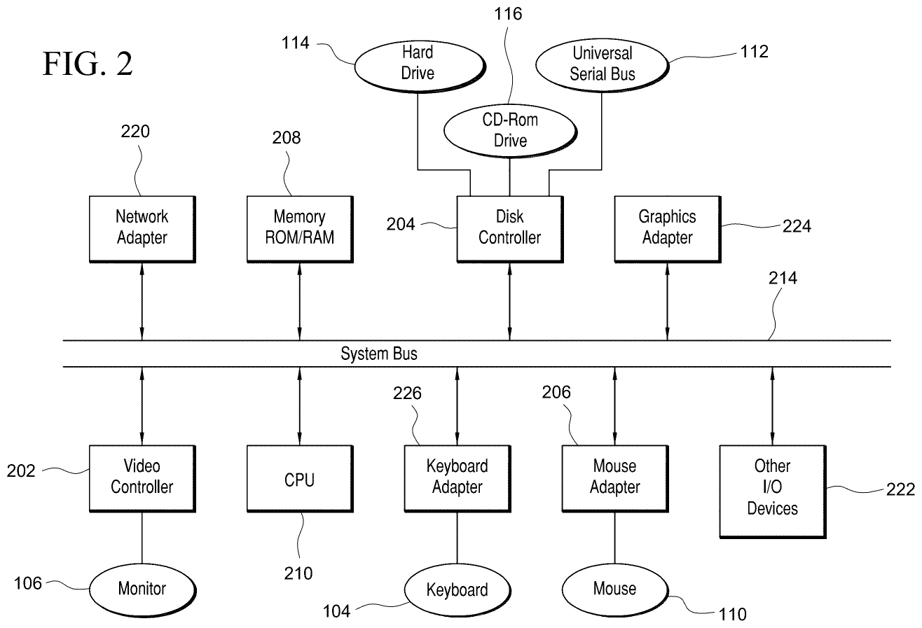

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

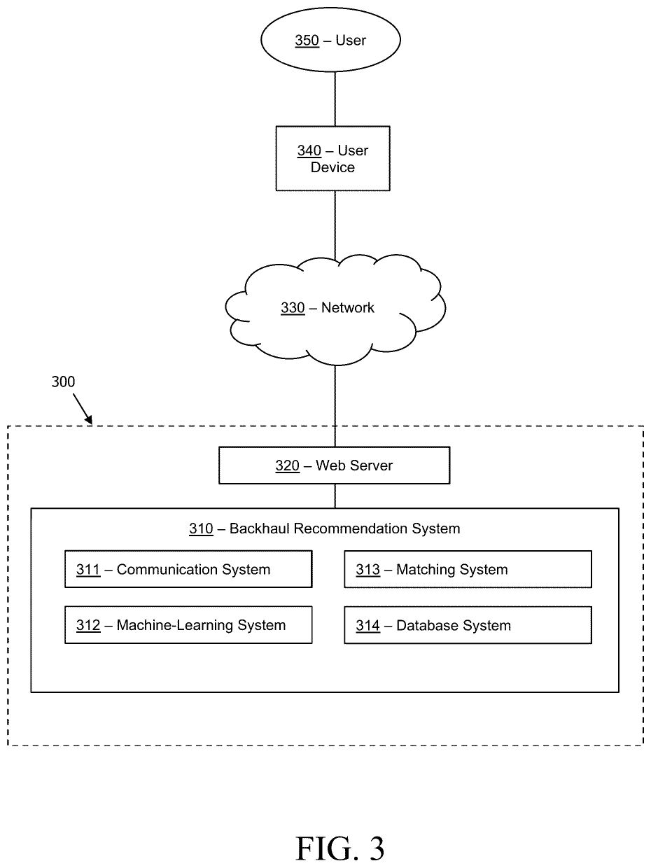

Turning ahead in the drawings, FIG. 3 illustrates a block diagram of a system 300 that can be employed for backhaul attachment recommendation and optimization, according to an embodiment. System 300 is merely exemplary, and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a backhaul recommendation system 310 and/or a web server 320. Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Backhaul recommendation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host backhaul recommendation system 310 and/or web server 320. Additional details regarding backhaul recommendation system 310 and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interface with backhaul recommendation system 310, such as to recommend backhaul attachment.

In some embodiments, an internal network that is not open to the public can be used for communications between backhaul recommendation system 310 and web server 320 within system 300. Accordingly, in some embodiments, backhaul recommendation system 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, or (ii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, backhaul recommendation system 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to backhaul recommendation system 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of backhaul recommendation system 310 and/or web server 320. In a similar manner, the processors and/or the non-transitory computer-readable media can be local and/or remote to each other.

Meanwhile, in many embodiments, backhaul recommendation system 310 and/or web server 320 also can be configured to communicate with one or more databases, such as a database system 314. The one or more databases can store inputs, constraints, data structures, and/or outputs used in recommending and/or optimizing backhaul attachment, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit, or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, backhaul recommendation system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, backhaul recommendation system 310 can include a communication system 311, a machine-learning system 312, a matching system 313, and/or database system 314. In many embodiments, various systems of backhaul recommendation system 310 can be modules of computing instructions (e.g., software modules) stored at non-transitory computer readable media that operate on one or more processors. In some embodiments, various systems of backhaul recommendation system 310 can be implemented in hardware. Backhaul recommendation system 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host backhaul recommendation system 310 and/or web server 320. Additional details regarding backhaul recommendation system 310 and the components thereof are described herein.

In a number of embodiments, recommending and/or optimizing backhaul attachment can be performed by system 300, backhaul recommendation system 310, and/or web server 320. Backhaul attachment can refer to inbound loads being picked up from vendors after outbound deliveries for transporting such inbound loads to the distribution center.

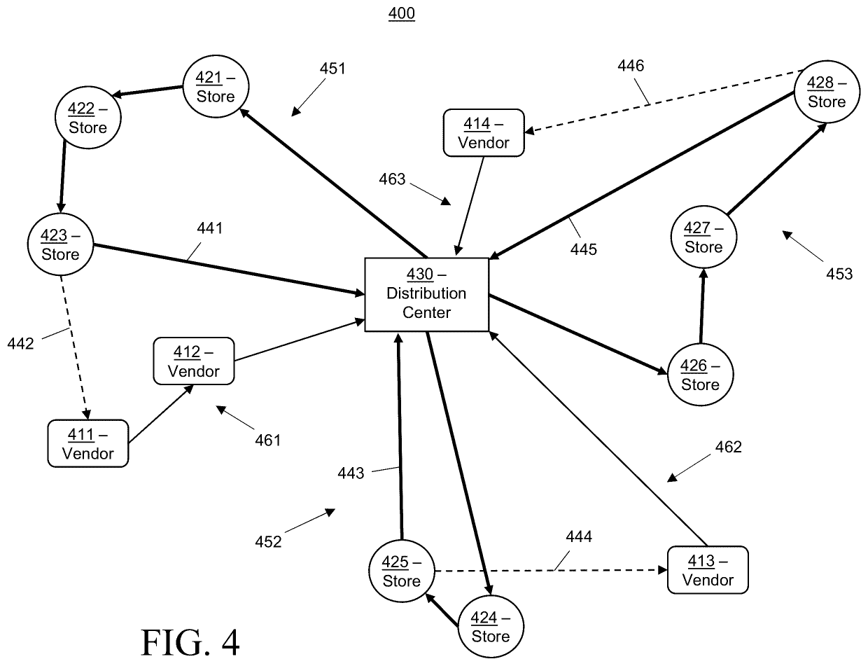

Turning ahead in the drawings, FIG. 4 illustrates an exemplary portion of a transportation network 400 associated with a distribution center 430. As shown in FIG. 4, transportation network 400 can include distribution center 430, stores 421-428, and vendors 411-414. Distribution center 430 can store items and send them to stores 421-428, such as when ordered by stores 421-428. Loads (also called transportation orders) can include outbound loads from distribution center 430 to one or more of stores 421-428 and inbound loads from one or more for vendors 411-414. As an example, as shown in FIG. 4, an outbound route 451 can involve a truck leaving distribution center 430 to deliver a load to store 421, then deliver a load to store 422, then deliver a load to store 423. Conventionally, the truck would then return to distribution center 430 from store 423 along segment 441. However, there are inbound loads from nearby vendors 411 and 412 to be delivered to distribution center 430, which is referred to as a backhaul 461, so the truck, instead of traveling along segment 441, can travel from store 423 to vendor 411 along segment 442 to pick up an inbound load, and then to vendor 412 to pick up an additional inbound load, then deliver those inbound loads to distribution center 430. In this example, backhaul 461 can be attached to outbound route 451.

As a second example, an outbound route 452 can involve a truck leaving distribution center 430 to deliver a load to store 424, then deliver a load to store 425. Conventionally, the truck would then return to distribution center 430 from store 425 along segment 443. However, there is an inbound load from a nearby vendor 413 to be delivered to distribution center 430, which is referred to as a backhaul 462, so the truck, instead of traveling along segment 443, can travel from store 425 to vendor 413 along segment 444 to pick up an inbound load, then deliver that inbound load to distribution center 430. In this example, backhaul 462 can be attached to outbound route 452.

As a third example, an outbound route 453 can involve a truck leaving distribution center 430 to deliver a load to store 426, then deliver a load to store 427, then deliver a load to store 428. Conventionally, the truck would then return to distribution center 430 from store 428 along segment 445. However, there is an inbound load from a nearby vendor 414 to be delivered to distribution center 430, which is referred to as a backhaul 463, so the truck, instead of traveling along segment 445, can travel from store 428 to vendor 414 along segment 446 to pick up an inbound load, then deliver that inbound load to distribution center 430. In this example, backhaul 463 can be attached to outbound route 453.

In many embodiments, determining whether to attach a backhaul to an outbound route can involve consideration of a number of factors, such as matching the type of the trailer with the commodity type of the load (e.g., dry, perishable, etc.), the stop sequence (pickup or delivery), locations, time windows at each location, and/or other suitable factors. In some embodiments, returning to the distribution center (e.g., 430) after delivering an outbound route (e.g., 451-453) with an empty truck is not desired, and it can be undesirable to send an empty truck (“deadhead”) to pick up a backup (e.g., 461-463). Attaching a backhaul (e.g., 461-463) after store deliveries on outbound routes (e.g., 451-453) can be desirable, as it can integrate inbound loads with outbound routes at each distribution center (e.g., 430).

When there are many backhauls and many releases (deliveries to stores), determining which ones to match can be a challenge. In a grocery distribution center, there is typically one regular release per day for each commodity from the distribution center. The commodity types can be dry or perishable, and there are several perishable types, such as MP (meat and produce), FDD (freezer, dairy, deli), F (freezer), MPDD (meat, produce, dairy, deli). As an example, the store releases in the next three days can include:
1. An FDD release on Day 0 (today) in the morning,
2. An MP release on Day 0 (today) in the afternoon,
3. An FDD release on Day 1 (tomorrow) in the morning,
4. An MP release on Day 1 (tomorrow) in the afternoon,
   (Etc.)

If the Day 0 FDD release has next day delivery, and the Day 0 MP release has next day delivery, and the Day 1 FDD release has same day delivery, all three of the deliveries to the stores will occur on the same day (tomorrow), so all three would be available options for attaching a backhaul with a pickup window on Day 1 (tomorrow). However, also considered are the commodity types, the time windows, the hours of service (HOS) regulations (specified by the U.S. Department of Transportation), and minimizing driver wait times. Challenges include the fact that at the current release time, future releases are unknown, and at the future release time, current release routes are already executed.

In many embodiments, backhaul attachment can attach inbound backhauls to outbound routes for minimizing total inbound and outbound transportation costs across all releases. The problem can be addressed for each outbound release. Inputs to the determination for each outbound release can be current outbound release input and output (e.g., today's orders), distribution centers, stores, pallets, shifts (e.g., dock out times), trailers, distances, configurations, HOS rules, list of outbound routes, and list of inbound backhauls within an upcoming period of time (e.g., the next 1, 2, 3, 4, 5, 6, or 7 days) in the same commodity type as the current release. Outputs from the determination can be the list of outbound routes with or without backhaul attached and the list of unassigned backhauls (which can be considered for future releases). An objective can be minimizing a transportation cost of attaching the backhauls, given that the future release routes which could also be good choices for the backhauls are unknown as of yet. The current releases are known, as they are for today's orders (orders of pallets) for same day or next-day delivery. The future releases are unknown, as they are for orders that have not yet been received.

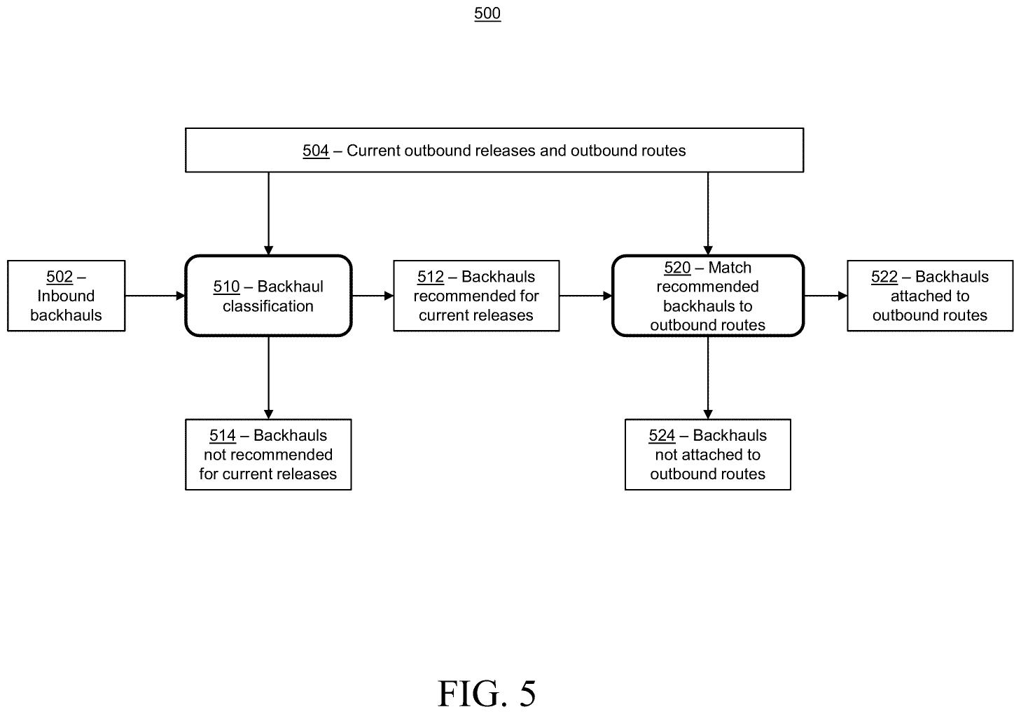

Turning ahead in the drawings, FIG. 5 illustrates a flow chart for a method 500 of backhaul attachment recommendation and optimization, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3) and/or backhaul recommendation system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

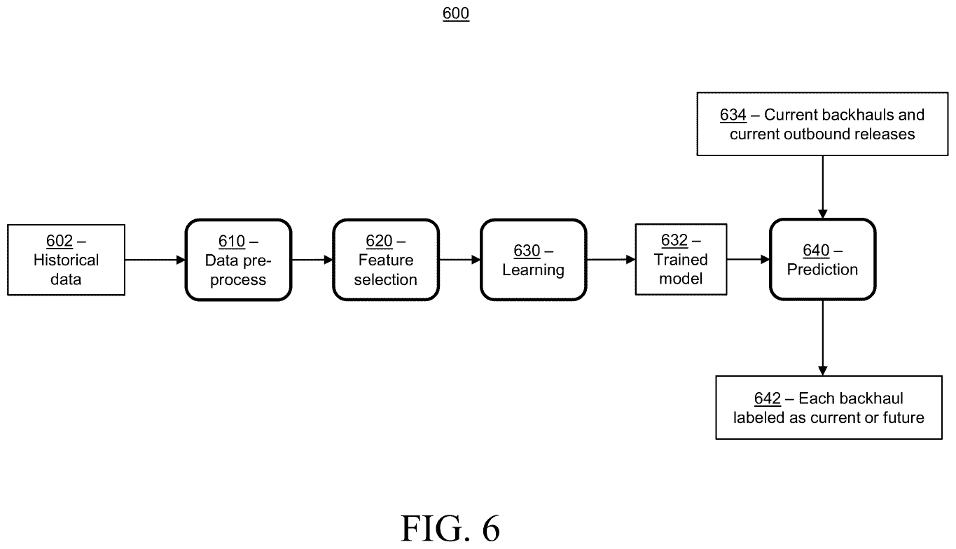

Referring to FIG. 5, method 500 can include an activity 510 of performing backhaul classification. In many embodiments, inbound backhauls 502 can information 504 about current outbound releases (in some embodiments, outbound routes are not considered at this stage) can be input into activity 510. Activity 510 can output (i) recommended backhauls 512, which are the backhauls from among inbound backhauls 502 that are recommended for matching with current releases, and (ii) backhauls 514 that are not recommended for current releases. Activity 510 can classify each of inbound backhauls 502 into either recommended backhauls 512 or backhauls 514. In a number of embodiments, a machine-learning model can be used for the classification. In several embodiments, the machine-learning model can be trained from historical data, such as historical final executions, which can be adjusted by users with insight on future releases. In some embodiments, activity 510 can be performed as shown in method 600 (FIG. 6, described below). In many embodiments, activity 510 can be performed by machine-learning system 312 (FIG. 3).

In a number of embodiments, method 500 also can include an activity 520 of matching recommended backhauls to outbound routes. In many embodiments, recommended backhauls 512 can be input into activity 520 along with information 504 about current outbound releases and outbound routes. Activity 520 can output (i) attached backhauls 522, which are the backhauls from among recommended backhauls 512 that are attached to outbound routes by activity 520, and (ii) backhauls 524 that are not attached to outbound routes. Activity 520 can either match recommended backhauls 512 with outbound routes to become attached backhauls 522, or otherwise to not be matched, and be include in backhauls 524. In a number of embodiments, a mixed integer programming model can be used to perform the matching in activity 520. In several embodiments, backhauls 514 and 524 can be left for future releases. In many embodiments, activity 520 can be performed by matching system 313 (FIG. 3). In many embodiments, backhauls 514, backhauls 522 with the matched outbound routes, and/or backhauls 524 can be output.

Turning ahead in the drawings, FIG. 6 illustrates a flow chart for a method 600 of performing backhaul classification, according to an embodiment. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped.

In many embodiments, system 300 (FIG. 3) and/or backhaul recommendation system 310 (FIG. 3) can be suitable to perform method 600 and/or one or more of the activities of method 600. In many embodiments, method 600 can be performed by machine-learning system 312 (FIG. 3). In these or other embodiments, one or more of the activities of method 600 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 600 and other activities in method 600 can include using a distributed network including distributed memory architecture to perform the associated activity. This distributed architecture can reduce the impact on the network and system resources to reduce congestion in bottlenecks while still allowing data to be accessible from a central location.

Referring to FIG. 6, method 600 can include an activity 610 of performing data pre-processing. In a number of embodiments, activity 610 can involve inputting historical data 602, which can include historical outbound data, such as stores, shifts, distance maps, etc., historical inbound data, such and backhaul inputs, such as backhaul opportunities that were available historically, and historical backhaul executions, such as backhauls that ended up being attached to outbound routes in the historical final executions. From this historical data, activity 610 can pre-process the data to prepare modeling data for each historical backhaul and release pair. In some embodiments, the input training data and output training data can be generated. The input training data can include a first type (“Type 1”) that includes the backhaul pickup window and service time, and a second type (“Type 2”) that include arrive time range (window) to pickup backhaul after single-stop store delivery, for each store in the current release. The output training data can include a label as to whether the final execution was current release or future release.

In several embodiments, method 600 can include an activity 620 of performing feature selection. In several embodiments, activity 620 can include intelligently selecting candidate stores with ranking based on incremental cost of backhaul attachment, using the corresponding second type of input training data together with the first type of input training data as features.

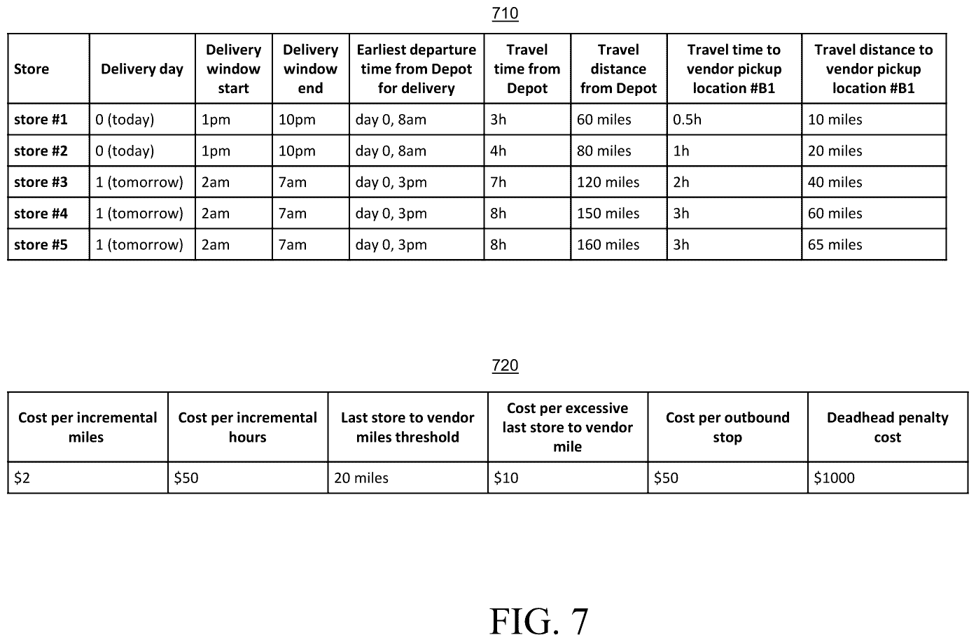

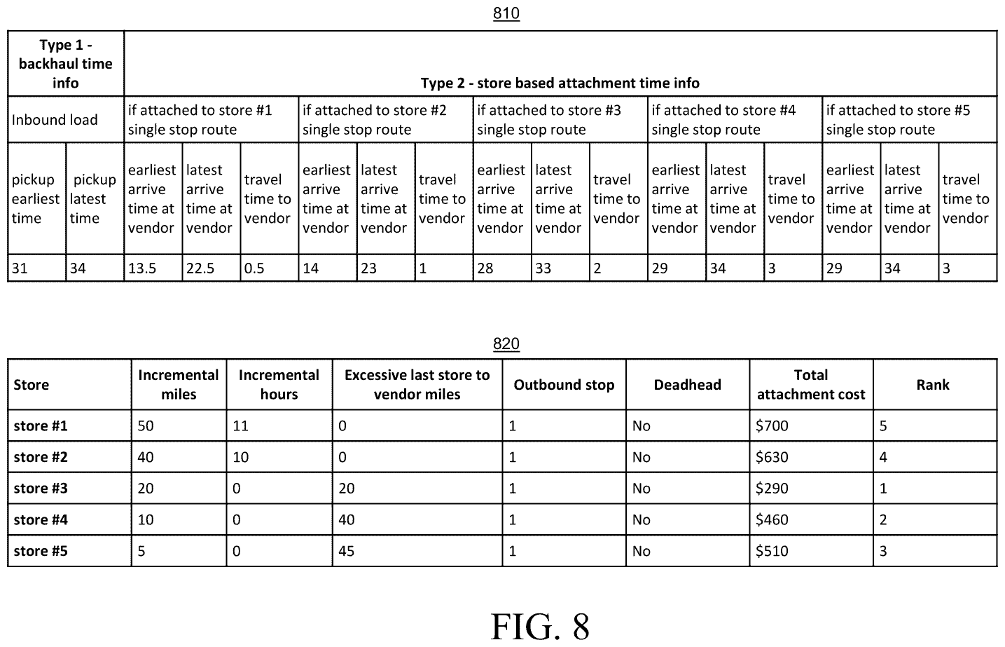

An exemplary data point and how it can be processed in activities 610 and 620 is shown in FIGS. 7-9. In this example, there is a backhaul #1 with pickup time window (7:00 am, 10:00 am) on day 1 (tomorrow), the pickup vendor location is 100 miles and 5 h away from the distribution center (Depot). The current outbound release has 5 stores with the information shown in table 710 of FIG. 7. The cost parameters for the backhaul attachment are shown in table 720 of FIG. 7. Activity 610 of performing data pre-processing can use the inputs in FIG. 7 to prepare the raw information as shown in table 810 of FIG. 8, in which all time-based values are transformed to the unit of hours).

In this example, activity 620 of performing feature selection can first calculate the cost of attaching the backhaul to each store as a single stop route, and sort the stores by rank. The output is shown in table 820 of FIG. 8. An example of determining the information in table 820 is provided next for store #1, for example (in the algorithm, it can be after an Hours of Service engine to get trip duration, which can include wait time(s), break(s), and layover(s) based on driving rules; here simplified calculations are used for illustration):

Incremental miles=total miles of whole trip with backhaul attached-total miles of whole trip no backhaul attached=(60+10+100)−(60+60)=50.

Incremental hours=total hours of whole trip with backhaul attached-total hours of whole trip no backhaul attached=(3+9+5)−(3+3)=11, where the first 9 hours is the total drive time and wait time at vendor location.

Excessive last store to vendor miles=0.

Outbound stop=1.

Deadhead: no.

Total attachment cost=$2*50+$50*11+0+$50=$700.

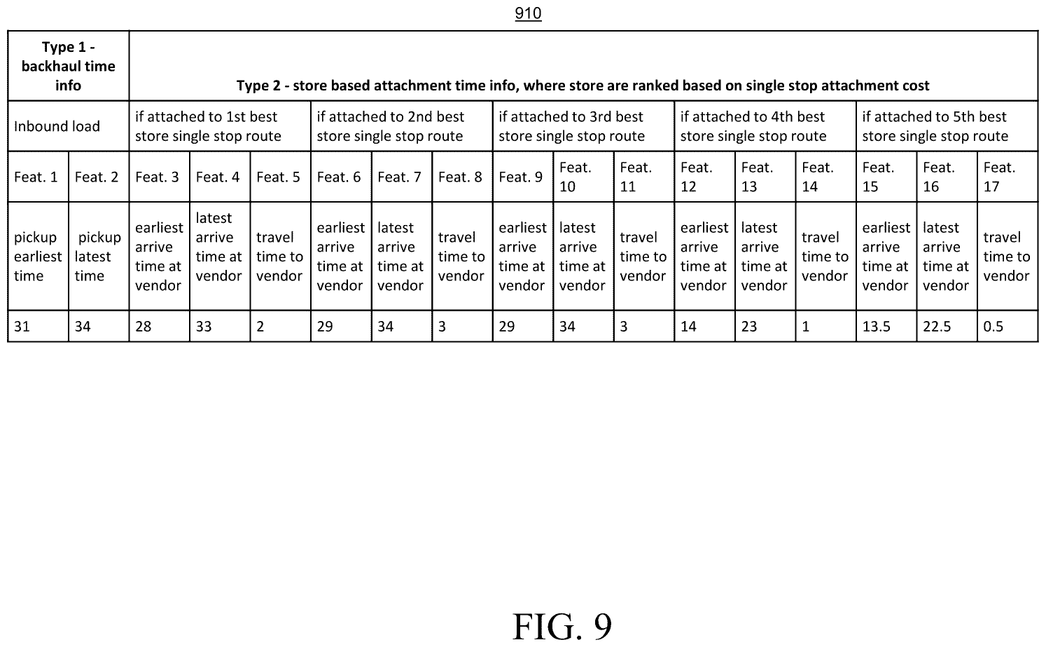

Based on the store ranking in table 820 and the information in table 810, the feature list (features 1-17) can be prepared as shown in table 910 of FIG. 9 for this exemplary data point.

Continue with FIG. 6, in several embodiments, method 600 can include an activity 630 of performing learning with a machine-learning model. In several embodiments, activity 630 can include using tree-based decision under a gradient boosting framework, such as the XGBoost model, using the features data generated in activity 620, such as table 910 (FIG. 9). In several embodiments, the learning can include evaluation and cross-validation, which can output a trained model 632. In many embodiments, the trained model can be stored, and can be updated by fetching new data, to retrain the model and evaluation metric. For example, a data source can include six months of historical data, involving 2287 backhaul-release pair data points with more than 100 features. This dataset can be randomly split into a training set having 1829 data points and a testing set having 458 data points. The XGBoost model can be learned from the training data. The training set had a k-fold mean cross validation score of 0.94. The testing set had an accuracy of 0.95 across four categories ((1) label current and predict current (accurate), (2) label future and predict future (accurate), (3) label current and predict future (inaccurate), and (4) label future and predict current (inaccurate)).

In a number of embodiments, method 600 can include an activity 640 of performing prediction using the machine-learning model. In several embodiments, current inputs 634, which can include backhauls and current output releases, can be input into trained model 632 to generate label outputs 642 for each backhaul, in which each of the backhauls can be labeled as either current (current release) or future (future release).

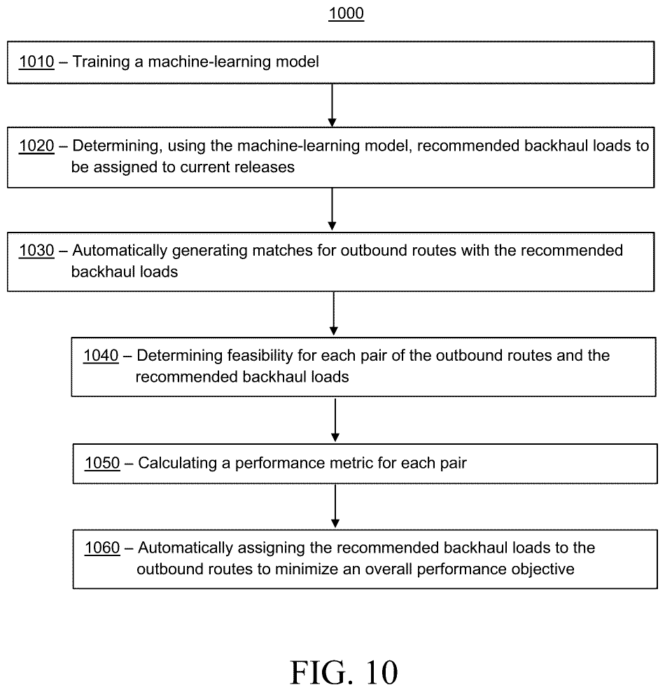

Turning ahead in the drawings, FIG. 10 illustrates a flow chart for a method 1000 of performing backhaul attachment recommendation and optimization, according to an embodiment. Method 1000 is merely exemplary and is not limited to the embodiments presented herein. Method 1000 can be employed in many different embodiments or examples not specifically depicted or described herein. In some embodiments, the procedures, the processes, and/or the activities of method 1000 can be performed in the order presented. In other embodiments, the procedures, the processes, and/or the activities of method 1000 can be performed in any suitable order. In still other embodiments, one or more of the procedures, the processes, and/or the activities of method 1000 can be combined or skipped.

In many embodiments, system 300 (FIG. 3) and/or backhaul recommendation system 310 (FIG. 3) can be suitable to perform method 1000 and/or one or more of the activities of method 1000. In these or other embodiments, one or more of the activities of method 1000 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1). In some embodiments, method 1000 and other activities in method 1000 can include using a distributed network including distributed memory architecture to perform the associated activity. This distributed architecture can reduce the impact on the network and system resources to reduce congestion in bottlenecks while still allowing data to be accessible from a central location.

Referring to FIG. 10, method 1000 can include an activity 1010 of training a machine-learning model based on pairs of historical backhauls and historical releases to recommend current releases or future releases. In a number of embodiments, activity 1010 can be similar or identical to activities 610-630 (FIG. 6). In several embodiments, the historical input data can be obtained using communication system 311 (FIG. 3), and machine-learning system 312 (FIG. 3) can be used to perform activity 1010.

In many embodiments, the machine-learning model is trained based on (i) a first type of input training data comprising backhaul pickup windows and service times and (ii) a second type of the input training data comprising arrival time windows to pick up backhauls after single-stop store deliveries. The first type of input training data can be similar or identical to the Type 1 data described above, and the second type of input training data can be similar or identical to the Type 2 data described above. In many embodiments, the machine-learning model is trained based on incremental performance metrics of backhaul attachment, using the first type of the input training data and the second type of the input training data, and performance factors.

In some embodiments, the incremental performance metrics can be incremental costs of backhaul attachment. In a number of embodiments, the performance factors can be cost factors, such as an incremental duration based on outbound routing, an incremental distance based on outbound routing, a threshold for empty miles, a penalty for empty miles, stops before a backhaul pickup, and/or an additional penalty for a dummy empty route. In some embodiments, the cost factors do not include factors involving the outbound routing in activity 1010.

In some embodiments, the machine-learning model is trained based on output training data of binary classifications based on historical backhaul outcomes. The binary classifications can each be current (current release) or future (future release). In some embodiments, the machine-learning model can include a tree-based gradient boosting model, such as XGBoost.

In several embodiments, method 1000 can include an activity 1020 of determining, using the machine-learning model, recommended backhaul loads to be assigned to current releases from among available backhaul loads. In a number of embodiments, activity 1020 can be similar or identical to activity 510 (FIG. 5) and/or activity 640 (FIG. 6). In several embodiments, machine-learning system 312 (FIG. 3) can be used to perform activity 1020.

In a number of embodiments, method 1000 can include an activity 1030 of automatically generating matches for outbound routes with the recommended backhaul loads. In a number of embodiments, activity 1030 can be similar or identical to activity 520 (FIG. 5). In several embodiments, matching system 313 (FIG. 3) can be used to perform activity 1030.

In several embodiments, activity 1030 can include an activity 1040 of determining feasibility for each pair of the outbound routes and the recommended backhaul loads. In many embodiments, activity 1040 can include determining if the trailer type matches for the outbound route matches the backhaul load, such as having sufficient capacity, having a matching commodity type (e.g., dry/perishable), HOS time feasibility, etc.

In a number of embodiments, activity 1030 can include an activity 1050 of calculating a performance metric for each pair of the outbound routes and the recommended backhaul loads. In many embodiments, the performance metric can be cost. In some embodiments, the performance factors (cost factors) listed above in connection with activity 1010 can be used, but in some embodiments can include factors involving outbound routing.

In several embodiments, activity 1030 can include an activity 1060 of automatically assigning the recommended backhaul loads to the outbound routes to minimize an overall performance objective. In several embodiments, activity 1060 of automatically assigning the recommended backhaul loads to the outbound routes can include solving a mixed integer programming formulation. In several embodiments, the mixed integer programming formulation can include decision variables, whether to assign backhaul i to route j, for all feasible route-backhaul pairs. An objective of the mixed integer programming formulation can be to minimize the total cost of attaching all the backhauls. In some embodiments, the mixed integer programming formulation can include constraints, such as (1) each of the recommended backhaul loads is assigned to a single one of the outbound routes; and (2) each of the outbound routes has at most one backhaul assignment from among the recommended backhaul loads. In some embodiments, a scale of the mixed integer programming formulation can, on average per release, can be 50 backhauls and 150 outbound routes, which can involve solving 7500 binary decision variables. In many embodiments, the mixed integer programming formulation can determine which outbound routes are good matches for the recommended backhauls, and can automatically assign these matches.

In many embodiments, the techniques described herein can provide a practical application and several technological improvements. In some embodiments, the techniques described herein can provide for backhaul attachment recommendation and optimization with a framework that can be flexibly adjusted for various alternative use cases, such as omitting activity 510 (FIG. 5) and instead performing activity 520 (FIG. 5) for all backhauls without classification, or instead performing activity 510 (FIG. 5) and instead embedding activity 520 (FIG. 5) into an outbound routing determination.

In many embodiments, the techniques described herein can be adaptive, with configurable performance parameters (e.g., cost parameters) introduced based on adaptive tradeoff between objectives specified by users (e.g., 350 (FIG. 3)). In several embodiments, the techniques described herein can be effective at a macro-level and/or micro-level to make decisions iteratively, with specified objectives. In many embodiments, the techniques described herein can be efficient, solving the mixed integer programming formulation within one minute per release. In a number of embodiments, automatically assigning backhauls by the techniques described herein has resulted in a significant increase acceptance by users of the assigned backhauls and a significant reduction of empty miles to attach backhauls.

Conventional approaches to vehicle routing problem with backhaul are deterministic in which all the backhauls and stores have the full information available. However, the techniques described herein can address the backhaul attachment problem in a larger scope that is not deterministic, across multiple outbound vehicle routing problems, while not all outbound information is available at the time the decisions are made. The significant constraints, such as time windows, HOS regulations, and other user specified requirements make the problem unique and challenging, beyond conventional approaches.

Various embodiments can include a computer-implemented method. The method can include training a machine-learning model based on pairs of historical backhauls and historical releases to recommend current releases or future releases. The method also can include determining, using the machine-learning model, recommended backhaul loads to be assigned to current releases from among available backhaul loads. The method additionally can include automatically generating matches for outbound routes with the recommended backhaul loads.

A number of embodiments can include a system including one or more processors and one or more non-transitory computer-readable media storing computing instructions that, when executed on the one or more processors, cause the one or more processors to perform certain operations. The operations can include training a machine-learning model based on pairs of historical backhauls and historical releases to recommend current releases or future releases. The operations also can include determining, using the machine-learning model, recommended backhaul loads to be assigned to current releases from among available backhaul loads. The operations additionally can include automatically generating matches for outbound routes with the recommended backhaul loads.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although backhaul attachment recommendation and optimization has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-10 may be modified, and that the foregoing discussion of certain of these embodiments does not necessarily represent a complete description of all possible embodiments. For example, one or more of the procedures, processes, or activities of FIGS. 5-6 and 10 may include different procedures, processes, and/or activities and be performed by many different modules, in many different orders. As another example, the systems and/or engines within system 300 (FIG. 3) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A computer-implemented method comprising:
training a machine-learning model based on pairs of historical backhauls and historical releases to recommend current releases or future releases;
determining, using the machine-learning model, recommended backhaul loads to be assigned to current releases from among available backhaul loads; and
automatically generating matches for outbound routes with the recommended backhaul loads.

2. The computer-implemented method of claim 1, wherein the machine-learning model is further trained based on (i) a first type of input training data comprising backhaul pickup windows and service times and (ii) a second type of the input training data comprising arrival time windows to pick up backhauls after single-stop store deliveries.

3. The computer-implemented method of claim 2, wherein the machine-learning model is further trained based on incremental performance metrics of backhaul attachment, using the first type of the input training data and the second type of the input training data, and performance factors.

4. The computer-implemented method of claim 3, wherein the performance factors comprise one or more of:
an incremental duration based on outbound routing;
an incremental distance based on outbound routing;
a threshold for empty miles;
a penalty for empty miles;
stops before a backhaul pickup; or
an additional penalty for a dummy empty route.

5. The computer-implemented method of claim 1, wherein the machine-learning model is further trained based on output training data of binary classifications based on historical backhaul outcomes.

6. The computer-implemented method of claim 5, wherein the binary classifications are each current or future.

7. The computer-implemented method of claim 1, wherein the machine-learning model comprises a tree-based gradient boosting model.

8. The computer-implemented method of claim 1, wherein automatically generating matches further comprises:
determining feasibility for each pair of the outbound routes and the recommended backhaul loads;
calculating a performance metric for each pair of the outbound routes and the recommended backhaul loads; and
automatically assigning the recommended backhaul loads to the outbound routes to minimize an overall performance objective.

9. The computer-implemented method of claim 8, wherein automatically assigning the recommended backhaul loads to the outbound routes comprises solving a mixed integer programming formulation.

10. The computer-implemented method of claim 9, wherein the mixed integer programming formulation comprises constraints comprising:
each of the recommended backhaul loads is assigned to a single one of the outbound routes; and
each of the outbound routes has at most one backhaul assignment from among the recommended backhaul loads.

11. A system comprising one or more processors and one or more non-transitory computer-readable media storing computing instructions that, when executed on the one or more processors, cause the one or more processors to perform operations comprising:
training a machine-learning model based on pairs of historical backhauls and historical releases to recommend current releases or future releases;
determining, using the machine-learning model, recommended backhaul loads to be assigned to current releases from among available backhaul loads; and
automatically generating matches for outbound routes with the recommended backhaul loads.

12. The system of claim 11, wherein the machine-learning model is further trained based on (i) a first type of input training data comprising backhaul pickup windows and service times and (ii) a second type of the input training data comprising arrival time windows to pick up backhauls after single-stop store deliveries.

13. The system of claim 12, wherein the machine-learning model is further trained based on incremental performance metrics of backhaul attachment, using the first type of the input training data and the second type of the input training data, and performance factors.

14. The system of claim 13, wherein the performance factors comprise one or more of:
an incremental duration based on outbound routing;
an incremental distance based on outbound routing;
a threshold for empty miles;
a penalty for empty miles;
stops before a backhaul pickup; or
an additional penalty for a dummy empty route.

15. The system of claim 11, wherein the machine-learning model is further trained based on output training data of binary classifications based on historical backhaul outcomes.

16. The system of claim 15, wherein the binary classifications are each current or future.

17. The system of claim 11, wherein the machine-learning model comprises a tree-based gradient boosting model.

18. The system of claim 11, wherein automatically generating matches further comprises:
determining feasibility for each pair of the outbound routes and the recommended backhaul loads;
calculating a performance metric for each pair of the outbound routes and the recommended backhaul loads; and
automatically assigning the recommended backhaul loads to the outbound routes to minimize an overall performance objective.

19. The system of claim 18, wherein automatically assigning the recommended backhaul loads to the outbound routes comprises solving a mixed integer programming formulation.

20. The system of claim 19, wherein the mixed integer programming formulation comprises constraints comprising:
each of the recommended backhaul loads is assigned to a single one of the outbound routes; and
each of the outbound routes has at most one backhaul assignment from among the recommended backhaul loads.
